(19) United States
(12) Patent Application Publication
(10) Pub. No.: US 2024/0362968 A1
(43) Pub. Date: Oct. 31, 2024

(54) DYNAMICALLY GENERATING GAMING CONTENT VIA PROMPT

(71) Applicant: LNW Gaming, Inc., Las Vegas, NV (US)

(72) Inventors: Martin S. LYONS, Henderson, NV (US); John GRIFFIN, Chicago, IL (US); David PRYOR, Elmhurst, IL (US); Kenneth Shawn SOONG, Henderson, NV (US); Muthu VELU, Schaumburg, IL (US); Qiaofeng YANG, Reno, NV (US)

(21) Appl. No.: 18/644,864

(22) Filed: Apr. 24, 2024

Related U.S. Application Data
(60) Provisional application No. 63/498,023, filed on Apr. 25, 2023.

(51) Int. Cl. G07F 17/32; G06N 20/00

(52) U.S. Cl. CPC G07F 17/3213; G06N 20/00; G07F 17/3206; G07F 17/3209; G07F 17/3237

(57) ABSTRACT

A system and method(s) to perform operations that include detecting user input that indicates use of a gaming machine. The operations further include gathering, in response to detection of the user input, prompt-related data. The prompt-related data can include any relevant or available information associated with use of, or a user of, the gaming machine. The operations further include generating, based on the prompt-related data, a prompt. The operations further include dynamically generating, via a machine learning model using the prompt, original gaming content. The operations further include presenting, via a presentation device of the gaming machine, the dynamically generated gaming content.

### CROSS-REFERENCE TO RELATED APPLICATION

This patent application claims priority benefit of U.S. Provisional Patent Application No. 63/498,023 filed Apr. 25, 2023. The entirety of the 63/498,023 Application is incorporated by reference herein.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc.

### FIELD

The present disclosure relates generally to system(s) and method(s) for generating and presenting gaming content, including use of artificial neural network model(s).

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines as well as those machines, or systems, that are easy to use.

Furthermore, there exist some challenges in developing games that present the most entertaining and exciting artwork, features, etc. For example, as games get more advanced, the designed gaming content increases in resolution and detail, thus also increasing in size and complexity. Therefore, animation of conventional gaming content can require improved or upgraded hardware (e.g., memory, graphics processing units, etc.) used to store, process, present, etc. the large and complex gaming content.

Therefore, there is a continuing need for wagering game machine manufacturers to continuously develop gaming features (e.g., innovative and/or interesting gaming content) that will improve the gaming experience for players. Furthermore, it would be beneficial to have a system that overcomes the conventional technical challenges and complexities associated with developing and animating ever more sophisticated gaming content.

### SUMMARY

According to an embodiment of the present disclosure, a system and/or method(s) to detect user input that indicates use of a gaming machine and gather, in response to detection of the user input, prompt-related data. The prompt-related data can include any relevant or available information associated with use of, or a user of, the gaming machine. The system and/or method(s) is further to generate, based on the prompt-related data, a prompt and dynamically generate, via a machine learning model using the prompt, original gaming content. The system and/or method(s) is further to present, via a presentation device of the gaming machine, the original gaming content.

According to an additional embodiment of the present disclosure, a system comprising one or more memory devices configured to store one or more instructions and one or more electronic processors. The one or more electronic processors are configured to execute the one or more instructions, which when executed cause the system to perform operations to detect, in response to user input, selection of constraint data associated with presentation requirements for gaming content via a gaming machine. The operations are further to train, based on electronic analysis of the constraint data, a machine learning model to dynamically generate original gaming content compliant with the constraint data. The operations are further to store, for access via a communications network, a version of the trained machine learning model for use by the gaming machine.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a diagram of an example network according to one or more embodiments of the present disclosure.

FIG. 2 is a schematic view of a gaming system according to one or more embodiments of the present disclosure.

FIG. 3 is a block diagram of a computer system according to one or more embodiments of the present disclosure.

FIG. 4 illustrates an example of a method flow of dynamically generating gaming content via a prompt according to one or more embodiments of the present disclosure.

FIG. 5A and 5B illustrate examples of gathering prompt-related data according to one or more embodiments of the present disclosure.

FIG. 6 illustrates an example of generating a prompt according to one or more embodiments of the present disclosure.

FIG. 7 illustrates an example of dynamically generating gaming content based on prompt data according to one or more embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings, and will herein be described in detail, at least some embodiments with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

The descriptive content herein provides advancement in the technology of animation and entertainment systems, particularly gaming machines. For example, one drawback to current gaming systems is that the game content needs to be stored in memory attached to the gaming machine. The media files for conventional content are large (so as to present the best quality) and require a commensurate amount of computer memory space. However, via use of one or more embodiments of the present disclosure, a gaming machine can dynamically generate, via an artificial intelligence model (e.g., a machine learning model), original (e.g., new, novel, innovative, imaginative, etc.) gaming content (e.g., during training, at runtime of a wagering game, etc.). In some embodiments, the gaming machine can dynamically generate the original gaming content to modify already existing gaming content and/or to add to existing game content. Furthermore, in some instances, the gaming machine can dynamically generate the original gaming content without needing to access pre-generated content and/or without needing access to large media files (e.g., high-resolution image files, high-quality pre-recorded animations, etc.). Rather, the gaming machine dynamically generates the original gaming content using a prompt, which requires storage and/or use of text data, which has a far lower memory requirement than storage of large media files. Furthermore, the gaming machine dynamically generates the gaming content using a prompt that was engineered based on all relevant information that was gatherable (e.g., available on existing databases, capturable by sensors, etc.) about the gaming session (e.g., about the relevant player, casino, game, jurisdiction, game-provider, etc.), such as player emotional state, player preferences, player history, game constraints, gaming or accounting information, help assistance requirements, etc. Thus, the dynamically generated content can be customized to the player or scenario, and hence produces more engaging, entertaining, and/or useful gaming content. Furthermore, because a machine learning model can be trained to dynamically generate a specific level or type of original content (which can be fine-tuned at runtime), based on game-provider-specific design constraints, licensable content constraints, jurisdictional constraints, player preference data, etc., the gaming machine can be assured to dynamically generate content that is approved and authorized for presentation by the game provider, jurisdictional bodies, etc. Furthermore, casino-operator users and/or authorized administrative users of the gaming machine can benefit from dynamically generated chatbot help screens, administrative controls, etc. related to a setup, administration, resolution, monitoring, etc. of the gaming machine or gaming session.

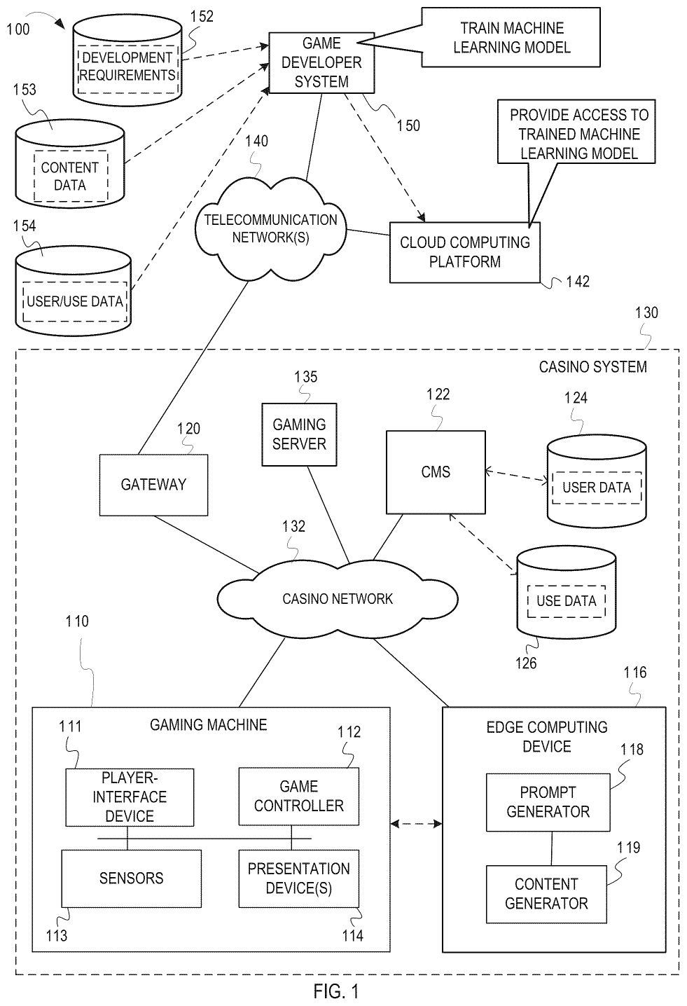

FIG. 1 is a diagram of an example network (“network 100”) according to one or more embodiments of the present disclosure. The network 100 includes a game developer system 150 communicatively coupled (e.g., connected within the network 100) to additional devices via one or more telecommunication networks (i.e., “telecommunication network(s) 140”) and via a local casino network 132. In some embodiments, the telecommunication network(s) 140 include, but are not limited to, the Internet, a computer network, a cell phone communication network, etc. The game developer system 150 is associated with a game provider entity that develops and provides gaming content (e.g., Light & Wonder, Inc.). The game developer system 150 it further connected to various sources of information used to develop the gaming content, such as development requirements (e.g., technical specifications, legal or jurisdictional requirements, game-design constraints, etc.) stored in database 152, content data (e.g., existing gaming content, synthetically-generated gaming content during machine-learning training, dynamically-generated gaming content from use of generative machine learning model in casinos, etc.) stored in database 153, user/use data (e.g., player-related data, technician-related data, casino-related data, etc.) stored in database 154, and so forth. The development requirements can include data related to game-function constraints (e.g., math models, thematic look, etc.), regulatory constraints, requirements for presentation of game events, hardware requirements, security requirements, and so forth. The content data may include content that is licensed for use by the game provider (e.g., stock images), trademarked content, content generated and/or used by the game developer for already-developed games, third-party content that the game provider is licensed to use in games developed by the game provider for a particular game theme/type/process, etc. The user/use data includes data about users and/or use of gaming machines that dynamically generate gaming content (e.g., statistics about player history of usage of dynamically generated gaming content, player reactions to dynamically generated gaming content, technician use of dynamically generated gaming content, etc.). In one example, the user/use data includes player-related data associated with a player account logged in via player interface device 111 (e.g., via the iView® player interface product manufactured by Light & Wonder, Inc). The game developer system 150 trains an artificial intelligence model, such as a machine learning model (e.g., a generative adversarial network, a text-to-image neural network, a Large Language Model, a deep learning model, a neural network model, etc.) to dynamically generate gaming content from a prompt. The prompt describes, or indicates in some way, characteristics of original content (e.g., imagery, sounds, chatbot content, help screens, etc.) for the machine learning model to dynamically generate for the gaming content. In one embodiment, the machine learning model is trained using, as parameters, hyperparameters, input values, etc., the design requirements, content data, use/user data, or other information, to dynamically generate, as output, gaming content that meets the constraints and/or requirements (e.g., as indicated by the development requirements, content data, user/use data, etc.). In one embodiment, the cloud computing platform 142 provides the basic (untrained) machine learning model (e.g., the basic machine learning algorithms, with established parameters as well as variable hyperparameters which are accessible, and modifiable, for fine-tuning to a particular purpose during training based on the data sets provided by the game developer system 150). Thus, in one embodiment, the game developer system 150 trains the generative machine learning model using the processing (e.g., Graphics Processor Unit (GPU) processing), storage (e.g., distributed memory storage), or other hardware capabilities of the cloud computing platform 142. In another embodiment, the game developer system 150 trains the machine learning model and then provides it for access online via the cloud computing platform 142. The cloud computing platform 142 makes the trained machine learning model accessible to edge computing device 116, for use to dynamically generate gaming content during use of gaming machine 110. Examples of the cloud computing platform 142 include the Amazon Web Services (AWS) cloud computing service by Amazon.com, Inc., the Google Cloud Platform (GCP) cloud computing service by Google LLC, the Azure Machine Learning (Azure ML) cloud computing service by Microsoft Corporation, and so forth.

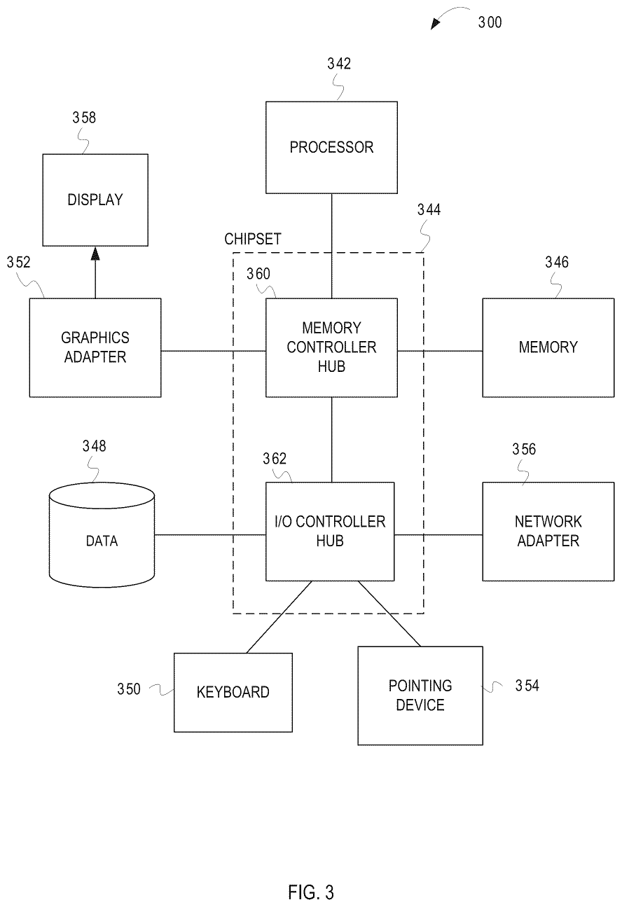

In one embodiment, gateway 120 is communicatively coupled via a gaming network, (e.g., via casino network 132) to casino management system (“CMS”) 122, which is communicatively coupled to the gaming machine 110. Gateway 120 may be a server, a desktop computer, a laptop, a smartphone, a gaming machine, or other form of electronic device having one or more processors, a computer memory, an electronic communications system (e.g., a bus, a network interface device, a wireless communications device, etc.), etc. For instance, gateway 120 may be computer system 300 described in FIG. 3.

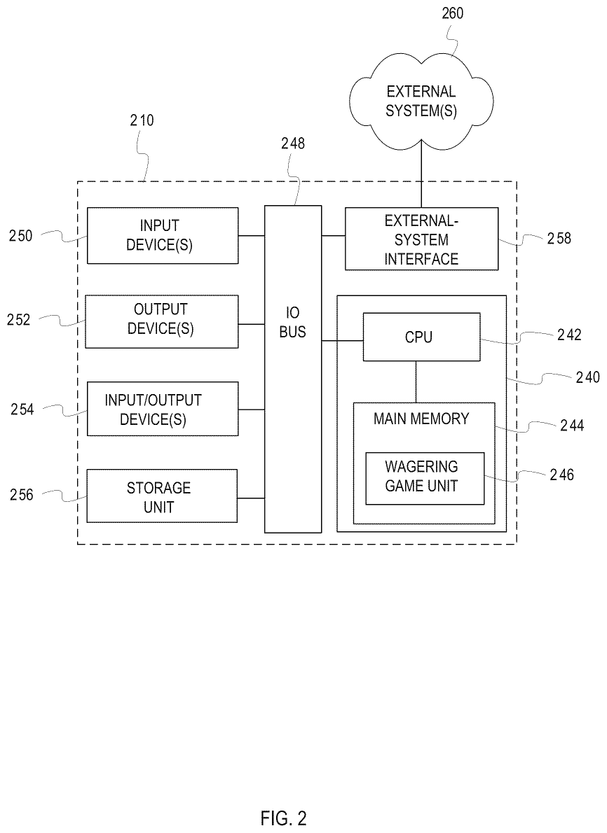

The gaming machine 110 includes player interface device 111, game controller 112, one or more sensors 113 (image sensors, sound sensors, three-dimensional depth sensors, etc.), and one or more presentation devices (“presentation device(s) 114”). One example of a gaming machine is gaming machine 210 described in FIG. 2. In one example, player interface device 111 may connect to, or be associated with, input/output device(s) 254 and/or external-system interface 258. Game controller 112 may be incorporated with game-logic circuitry 240. Sensors 113 may be connected to, or associated with, input device(s) 250. Presentation device(s) 114 may be connected to, or associated with, output device(s) 252 and/or input/output devices 254 (e.g., for touch-screen devices). Edge computing device 116 may be connected to, and/or incorporated with gaming machine 110 via external-system interface 258. In one embodiment, edge computing device 116 may be connected to a group (e.g., section, bank, etc.) of gaming machines (e.g., multiple versions of gaming machine 110). In one embodiment, edge computing device 116 is part of, or incorporated into, a centralized local-network device, a casino-network server, (e.g., gaming server 135, CMS 122, etc.). In one example, edge computing device 116 is a host to prompt generator 118 and content generator 119. Prompt generator 118 generates (i.e., intelligently engineers) a prompt based on gathered prompt-related data associated with a gaming session. Content generator 119 dynamically generates gaming content based on the prompt. In one embodiment, edge computing device 116 is optional; thus, prompt generator 118 and content generator 119 may instead be incorporated into gaming machine 110 (e.g., incorporated into game controller 112, incorporated into game-logic circuitry 240, etc.).

CMS 122 is authorized to perform transactions with, and/or to securely communicate with, player interface device 111. In some embodiments, some combination of one or more of player interface device 111, CMS 122, gateway 120, and/or one or more data storage devices (e.g., database 124, which stores player-related data) may be collectively referred to as a “player tracking system,” a “patron management system,” etc., or more generally as, or part of, the casino system 130. CMS 122 provides (via player interface device 111) “system-based content” and/or “system-based services.” System-based content and/or system-based services may include, but are not necessarily limited to, content related to player benefits, casino services, marketing bonuses, promotions, advertisements, beverage or dining services, or any other information that is relevant to the player's gaming experience other than the wagering game itself. Content for a wagering game may be referred to as game content. Game content, for instance, includes game assets of the wagering game, content related to a bet placed on the game (e.g., bet meters, pay tables, payout/collection, credit meters, number of lines selected for betting, an amount bet per line, a maximum bet, etc.), game play elements of the game (e.g., reels, indicia, game symbols,), game instructions, etc. The term “gaming content,” as used herein, comprises both system-based content and game content. Examples of the CMS 122 include, but are not limited to, one or more of the ACSC Casino Management System® product, the SDS® slot-management product, the CMP® player-tracking product, the Elite Bonusing Suite® product, or the Bally Unified Wallet® product, all available from Light & Wonder, Inc.

In some embodiments, elements of the casino system 130 are configured to use a trained machine learning model (e.g., the casino system 130 is authorized, to coordinate communications with the cloud-computing platform 142 to access the trained machine learning model), to engineer prompts (e.g., based on gathered prompt-related data) and dynamically generate gaming content (e.g., at game runtime). By dynamically generating gaming content during game runtime (e.g., while play occurs), the casino system 130 (e.g., via gaming machine 110 and/or via associated edge-computing device 116), can generate interesting and exciting original imagery, sounds, etc. for a game without requiring the transfer and storage of large and complex images from the game provider. Rather, the casino system 130 uses a trained machine learning model (and any associated processing elements, such as game controller 112, prompt-generator 118, etc.) to gather prompt-related data (associated with the game-play session, player, environment, etc.) to engineer a prompt, which the trained machine learning model uses to dynamically generate (e.g., via content generator 119) original gaming content (e.g., original imagery, original sounds, etc.) for presentation (e.g., for animated presentation) via presentation device(s) 114. Because the machine learning model has been trained on the various constraints and requirements, then the machine learning model can dynamically generate and animate gaming content that meets the necessary conditions or requirements (e.g., meets game-design constraints, meets regulatory rules/regulations for gaming content, etc.). Furthermore, because the casino system 130 has access to other information (e.g., casino-related data, player-related data, environmental data, etc.), the casino system 130 can (via the machine learning model) engineer a prompt, based on the available information, and dynamically generate gaming content relevant to a particular situation, to a particular individual, etc.

FIG. 2 is schematic view of a gaming system according to at least some aspects of the disclosed concepts. Referring to FIG. 2, a gaming machine 210 includes game-logic circuitry 240 (e.g., securely housed within a locked box inside a gaming cabinet). The game-logic circuitry 240 includes a central processing unit (CPU) 242 connected to a main memory 244 that comprises one or more memory devices. The CPU 242 includes any suitable processor(s), such as those made by Intel Corporation and Advanced Micro Devices, Inc. By way of example, the CPU 242 includes a plurality of microprocessors including a primary (e.g., master) processor, a secondary (e.g., worker, helper, etc.) processor, a parallel processor, etc. Game-logic circuitry 240, as used herein, comprises any combination of hardware, software, or firmware disposed in or outside of the gaming machine 210 that is configured to communicate with or control the transfer of data between the gaming machine 210 and a bus, another computer, processor, device, service, or network. The game-logic circuitry 240, and more specifically the CPU 242, comprises one or more controllers or processors and such one or more controllers or processors need not be disposed proximal to one another and may be located in different devices or in different locations. The game-logic circuitry 240, and more specifically main memory 244, comprises one or more memory devices which need not be disposed proximal to one another and may be located in different devices or in different locations. The game-logic circuitry 240 is operable to execute all of the various gaming methods and other processes disclosed herein. The main memory 244 includes a wagering-game unit 246. In one embodiment, the wagering-game unit 246 causes wagering games to be presented, such as video poker, video blackjack, video slots, video lottery, etc., in whole or part.

The game-logic circuitry 240 is also connected to an input/output (I/O) bus 248, which can include any suitable bus technologies, such as an AGTL+frontside bus and a PCI backside bus. The I/O bus 248 is connected to various input devices 250, output devices 252, and input/output devices 254.

By way of example, the output devices 252 may include a primary presentation device, (e.g., primary display), a secondary presentation device, (e.g., a secondary display), and one or more audio speakers. The primary presentation device or the secondary presentation device may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices, the audio speakers, lighting assemblies, and/or other devices associated with presentation are collectively referred to as a “presentation assembly” of the gaming machine 210. The presentation assembly may include one presentation device (e.g., the primary presentation device), some of the presentation devices of the gaming machine 210, or all of the presentation devices of the gaming machine 210. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device and/or the secondary presentation device, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 210. The gaming machine 210 may include a touch screen(s) mounted over the primary or secondary presentation devices, buttons on a button panel, a bill/ticket acceptor, a card reader/writer, a ticket dispenser, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen, buttons, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

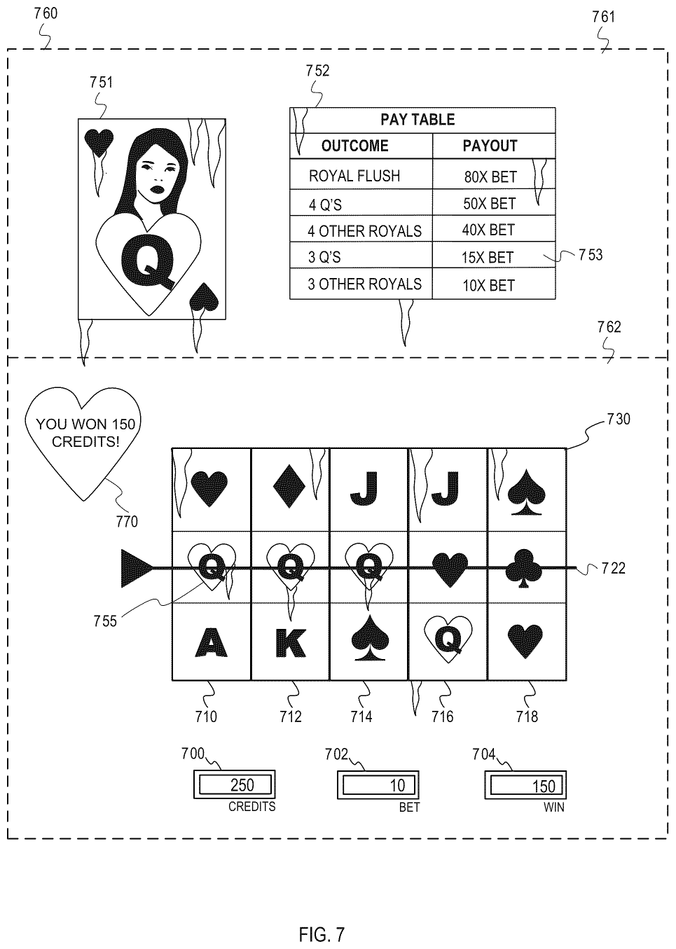

The input/output devices 254 include one or more value input/payment devices and value output/payout devices. In order to deposit cash or credits onto the gaming machine 210, the value input devices are configured to detect a physical item associated with a monetary value that establishes a credit balance on a credit meter (e.g., see credit meter 700 in FIG. 7). The physical item may, for example, be currency bills, coins, tickets, vouchers, coupons, cards, and/or computer-readable storage mediums. The deposited cash or credits are used to fund wagers placed on the wagering game played via the gaming machine 210. Examples of value input devices include, but are not limited to, a coin acceptor, a bill/ticket acceptor (e.g., a bill validator), a card reader/writer, a wireless communication interface for reading cash or credit data from a nearby mobile device, and a network interface for withdrawing cash or credits from a remote account via an electronic funds transfer. In response to a cashout input that initiates a payout from the credit balance on the “credits” meter, the value output devices are used to dispense cash or credits from the gaming machine 210. The credits may be exchanged for cash at, for example, a cashier or redemption station. Examples of value output devices include, but are not limited to, a coin hopper for dispensing coins or physical gaming tokens (e.g., chips), a bill dispenser, a card reader/writer, a ticket dispenser for printing tickets redeemable for cash or credits, a wireless communication interface for transmitting cash or credit data to a nearby mobile device, and a network interface for depositing cash or credits to a remote account via an electronic funds transfer.

The I/O bus 248 is also connected to a storage unit 256 and an external-system interface 258, which is connected to external system(s) 260 (e.g., wagering-game networks, communications networks, etc.).

The external system(s) 260 includes, in various aspects, a gaming network, other gaming machines or terminals, a gaming server, a remote controller, communications hardware, or a variety of other interfaced systems or components, in any combination. In yet other aspects, the external system(s) 260 comprises a player's portable electronic device (e.g., cellular phone, electronic wallet, etc.) and the external-system interface 258 is configured to facilitate wireless communication and data transfer between the portable electronic device and the gaming machine 210, such as by a near-field communication path operating via magnetic-field induction or a frequency-hopping spread spectrum RF signals (e.g., Bluetooth, etc.).

The gaming machine 210 optionally communicates with the external system(s) 260 such that the gaming machine 210 operates as a thin, thick, or intermediate client. The game-logic circuitry 240-whether located within (“thick client”), external to (“thin client”), or distributed both within and external to (“intermediate client”) the gaming machine 210-is utilized to provide a wagering game on the gaming machine 210. In general, the main memory 244 stores programming for a random number generator (RNG) and game-outcome logic. Furthermore, in some embodiments, the main memory stores at least some gaming content (e.g., art, sound, etc.) and/or dynamically generates gaming content that has is approved or authorized for presentation (e.g., the gaming content has either (1) received regulatory approval from a gaming control board or commission and is verified by a trusted authentication program in the main memory 244 prior to game execution or (2) is dynamically generated via an artificial intelligence model, such as a machine learning model that is trained to generate content that is compliant with regulatory, or other, requirements). In one example, an authentication program generates a live authentication code (e.g., digital signature or hash) from the memory contents and compares it to a trusted code stored in the main memory 244. If the codes match, authentication is deemed a success and the game is permitted to execute. If, however, the codes do not match, authentication is deemed a failure that must be corrected prior to game execution. Without this predictable and repeatable authentication, the gaming machine 210, external system(s) 260, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 242 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 242 when executing the game-outcome logic to determine a resultant outcome for that instance of the wagering game. The resultant outcome is then presented to a player of the gaming machine 210 by accessing associated game assets, required for the resultant outcome, from the main memory 244. The CPU 242 causes the game assets to be presented to the player as outputs from the gaming machine 210 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 210 may be used to play centrally determined games. Centrally determined games are a type of game whose outcomes are determined by a central server and delivered to player terminals (e.g., to be displayed in an entertaining fashion). It includes, but is not limited to, Class 2 games, electronic pull-tab games, electronic scratch ticket games, historical horse racing, bingo games, etc. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 210 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

FIG. 3 is a block diagram of a computer system 300 according to one or more embodiments. The computer system 300 includes at least one processor 342 coupled to a chipset 344, as indicated in dashed lines. Also coupled to the chipset 344 are memory 346, a storage device 348, a keyboard 350, a graphics adapter 352, a pointing device 354, and a network adapter 356. A display 358 is coupled to the graphics adapter 352. In one embodiment, the functionality of the chipset 344 is provided by a memory controller hub 360 and an I/O controller hub 362. In another embodiment, memory 346 is coupled directly to the processor 342 instead of to the chipset 344.

The storage device 348 is any non-transitory computer-readable storage medium, such as a hard drive, a compact disc read-only memory (CD-ROM), a DVD, or a solid-state memory device (e.g., a flash drive). Memory 346 holds instructions and data used by processor 342. The pointing device 354 may be a mouse, a track pad, a track ball, or another type of pointing device, and it is used in combination with the keyboard 350 to input data into the computer system 300. The graphics adapter 352 displays images and other information on the display 358. The network adapter 356 couples the computer system 300 to a local or wide area network.

As is known in the art, the computer system 300 can have different and/or other components than those shown in FIG. 3. In addition, the computer system 300 can lack certain illustrated components. In one embodiment, the computer system 300 acting as the gateway 120 (FIG. 1) may lack the keyboard 350, pointing device 354, graphics adapter 352, and/or display 358. Moreover, the storage device 348 can be local and/or remote from the computer system 300 (such as embodied within a storage area network (SAN). Moreover, other input devices, such as, for example, touch screens may be included.

The network adapter 356 (may also be referred to herein as a communication device) may include one or more devices for communicating using one or more of the communication media and protocols discussed above with respect to FIG. 1, or FIG. 2.

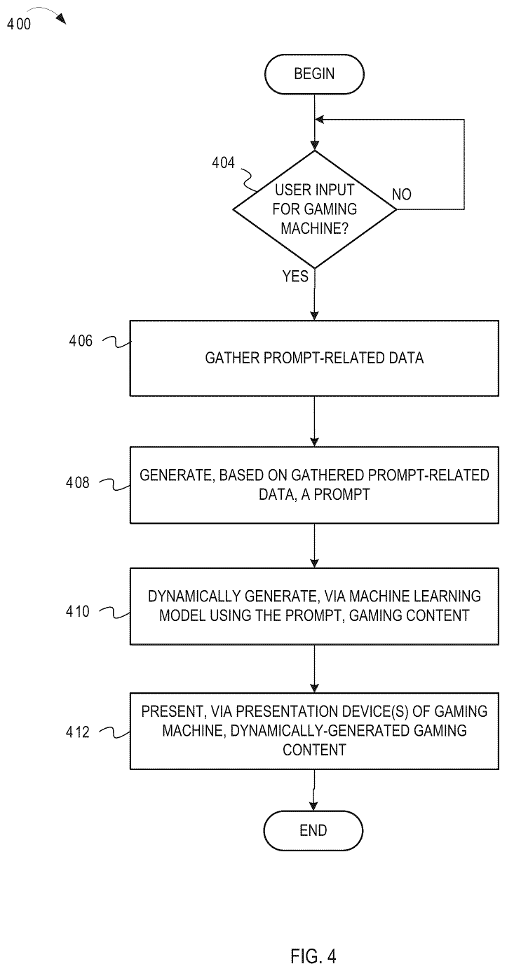

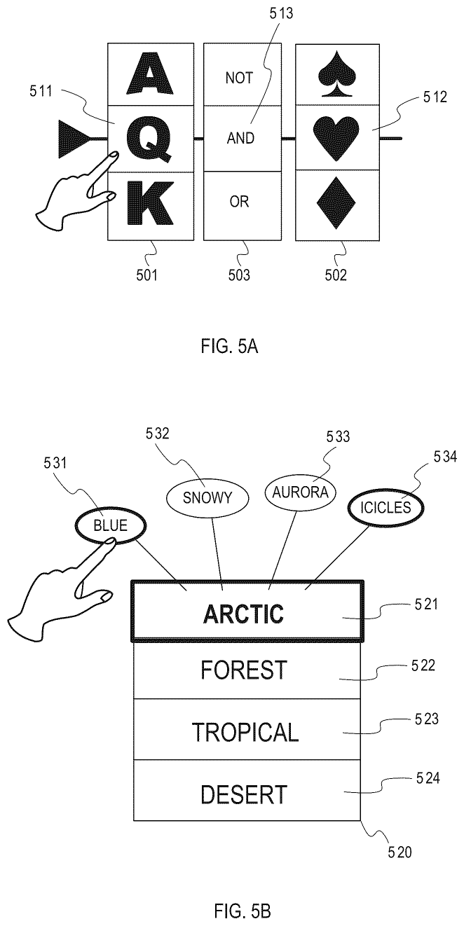

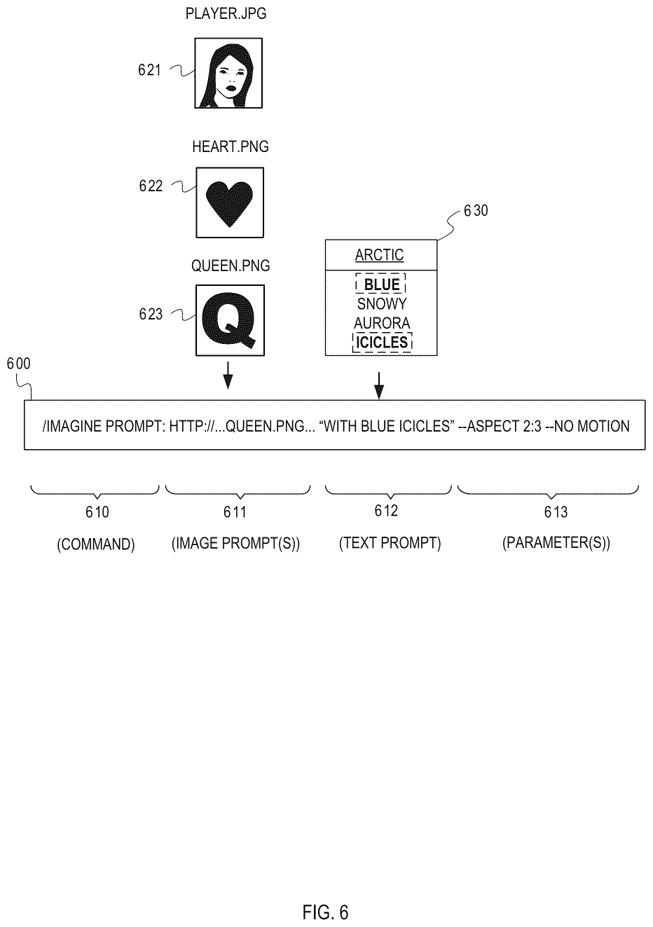

In addition, some or all of the components of this general computer system 300 of FIG. 3 may be used as part of the processor and memory discussed above with respect to the systems or devices described for FIG. 1, FIG. 2, FIG. 4, FIG. 5A, FIG. 5B, FIG. 6, or FIG. 7.

In some embodiments, a gaming system may comprise several such computer systems 300. The gaming system may include load balancers, firewalls, and various other components for assisting the gaming system to provide services to a variety of user devices.

The computer system 300 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on storage device 348, loaded into memory 346, and executed by processor 342.

FIG. 4 illustrates an example of a method flow (“flow 400”) of dynamically generating gaming content via a prompt according to one or more embodiments of the present disclosure. The description of FIG. 4 refers to a “processor” that performs operations associated with the flow 400. It should be noted that the reference to the processor may refer to the same physical processor or it may be one of a set of a plurality of processors. The set of processors may operate in conjunction with each other and may be distributed across various networked devices (e.g., across the network 100). The types of processors may include a central processing unit, a graphics processing unit, any combination of processors, etc. In one embodiment, the processor may be included in, or refer to, to one or more devices of the network 100, such as any one of the devices connected via the casino network 132 (e.g., gateway 120, CMS 122, gaming machine 110, player interface device 111, etc.) or any device connected via the telecommunications network 140 (e.g., the game developer system 150, the cloud-computing platform 142, etc.). In one embodiment, the processor may be the central processing unit (CPU) 242 (see FIG. 2) or a processor in another device mentioned herein, such as the processor 342 associated with the computer 300, a table controller, a card-handling device, a camera controller, a game controller (e.g., game controller 112), a gaming server (e.g., gaming server 135), etc.

Occasionally, the flow 400 will refer to FIG. 1, FIG. 2, FIG. 3, FIG. 5A, FIG. 5B, FIG. 6, or FIG. 7 to describe various embodiments.

Referring to FIG. 4, the flow 400 begins, then, at processing block 404, a processor determines whether user input is detected. The user input indicates some use of the gaming machine, such as user input that initiates play of a wagering game presented by the gaming machine, user input that configures, attends to, manages, or otherwise uses the gaming machine during a gaming session or in connection with a gaming session, etc. For example, in one embodiment the processor detects placement of a wager for a wagering game conducted via the gaming machine. With regard to the present disclosure, the gaming machine may be any type of gaming terminal or machine and may have varying structures and methods of operation. For example, in some aspects, the gaming machine is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine may take any suitable form, such as floor-standing models as shown, handheld mobile units, bartop models, workstation-type console models, etc. Further, the gaming machine may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

Referring still to FIG. 4, the flow 400 continues at processing block 406, where a processor gathers, in response to detection of the user input, prompt-related data. The processor gathers the prompt-related data for use in generating (e.g., engineering) the prompt (e.g., at processing block 408), which prompt is used (at processing block 410) as values associated with one or more of input, parameters, hyperparameters, etc. for the machine learning model. Prompt-related data can be any type of data associated with a wagering game session, such as, but not limited to, data associated with the wagering game (e.g., wagering game outcome data, random number generation, game odds, game constraints, bet levels, game theme, progressive jackpot values, game state, game classifications (e.g., class 3, class 2, etc.), game settings and/or configurations, game help files, pay table data, etc.), data associated with a user (e.g., player profile data, player account data, player betting levels, player preferences, player statistics, player activity, player emotional state, administrator or technician use, etc.), data associated with a gaming environment of the gaming machine and/or participant(s), data obtained from cameras, microphones, or other environmental sensors, and so forth.

In one example, the processor detects, as the prompt-related data, game-related data, such as game-outcome data, game-constraint data, etc. For instance, game outcome data is data associated with a random outcome of play (e.g., a bet and a spin) of a wagering game. In one example, game-outcome data includes randomly generated values associated with a game outcome for the wagering game, such as the randomly generated numbers used to represent a reel-stop configuration of symbols which occurs as a result of a bet placed in a slot-type wagering game. In another example, as described for FIG. 2, the gaming machine 210 may be used to play centrally determined games, such as electronic pull-tab and bingo games. For example, the processor can (e.g., for an electronic pull-tab game) detect, as game-outcome data, an RNG value associated with one outcome, selected from a pool (e.g., a pool of possible outcomes, a pool of a randomized distribution of outcomes, etc.). For an electronic bingo game, the processor can detect, as the game-outcome data, an RNG value used to randomly draw numbers that players can match against numbers printed on an electronic bingo card and/or which a gaming machine can present as a slot-type outcome (based on the RNG value). Thus, in one example, game-related data is an outcome value (e.g., a prize amount, an amount of credits won, etc.) of a first type of wagering game (e.g., a bingo type game); at a later stage (e.g., see processing block 410), the processor can dynamically generate gaming content to present the outcome value as a second type of wagering game (e.g., as an outcome for a slot type game).

In another example, the processor can detect game-related data by detecting animation constraints or requirements related to a game theme, game mechanic, game instruction, etc. For instance, a game may have a requirement that dynamically generated artwork must follow a “forest” theme. Hence, the processor can detect (e.g., via communication with the game controller 112) the forest theme for the game being played via the gaming machine 110. Hence, the processor may require the use of the word “forest” in the prompt, or may interpret the prompt text string in the context of a “forest” theme, thus dynamically generating (e.g., at processing block 410) gaming content that has original imagery of forest themed artwork. In another example, the processor can detect game-related data by detecting any pre-generated (starting point) artwork that is relevant to a particular game, theme, subject, etc.

In another example, the processor detects, as prompt-related data, user-related data, such as data associated with a player of the wagering game, a technician of the gaming machine, a communicatively coupled user device, etc. In some embodiments, the user-related data comprises player-related data, such as player preference data, player game history, player account settings, player profile data, patron loyalty account data, player betting history data, player game selection data, player identity data, player biometric data, player motion or activity data, player location data, player appearance data, player sound data, etc. In one example, a player can interact with player interface device (e.g., player interface device 111), such as by inserting a player card into a card slot of the player interface device or by connecting electronically or wirelessly via a mobile device, such as a player smartphone with an application that communicates with the player interface device. Referring momentarily to FIG. 1, in some embodiments, player interface device 111 is communicatively coupled to the game controller 112 and is configured to communicate with the game controller 112. In some embodiments, the player interface device 111 is configured to present system-based content, such as content related specifically to a player account (such as customer loyalty benefit information, earned rewards points, player funds, promotions, bonus games, etc.). The player interface device 111 can also provide access to casino services such as electronic drink deliveries, ordering tickets to casino entertainment, redeeming rewards, etc. In some embodiments, the player interface device 111 is an iView® player interface product by Light & Wonder, Inc. An example description of the iView® product can be found in U.S. Pat. No. 8,241,123 to Kelly et al., the entirety of which is hereby incorporated by reference. Examples of various devices, including a gaming machine and/or pairing of a gaming machine to a wireless communication device, are described in detail in U.S. Pat. No. 10,643,431 to Chesworth et al. and/or U.S. Pat. No. 10,068,417 to Toohey et al. U.S. Pat. Nos. 8,241,123 and 10,068,417 are each hereby incorporated by reference in their respective entireties.

In some embodiments, the processor detects, as user-related data, user images, audio, location, orientation, etc. such as via analysis of images, audio, or other data of the user captured by sensors or detection devices (e.g., images captured via light sensors in cameras, audio captured via sound sensors in microphones, 3D depth data captured via Light Detection and Ranging (LIDAR) sensors, location data captured via global positioning system (GPS), etc.) and/or based on information obtained from any other gaming device, network device, internal casino locator devices, local network node or location identifier, etc. The user-related data can include images of the user in a non-emotional state (e.g., image(s) taken of the player from a user profile, images captured of the player at game login, etc.), then capture images of the player during the game play, such as via computer vision or other methods, to detect an emotional state of the user (e.g., different from the baseline, non-emotional state). In one example, the processor can detect, as player-related data, a recent play history of the player (e.g., the last spin outcome, the last few spin outcomes, recent bet amounts or wagering patterns, recent game theme(s) or type(s) selected, etc.). Further, in another example, the processor can detect, as player-related data, player activity (e.g., user input via buttons or keyboard, player reactions, player sounds, spoken words, grunts, non-verbal emotional expressions, player motions, etc.).

In some examples, as mentioned, the processor can detect user-related data via specific sensors or location tracking devices. However, in some instances, a noisy gaming environment can interfere with detection of user-related sounds (e.g., the noisy environment can interfere with collection of voice details for accurate speech-to-text conversion). Furthermore, user input via on- screen keyboard is time consuming and cumbersome. Thus, in some embodiments, the processor provides user-selectable options for a user to indicate preferences regarding prompt data. The user-selectable options may be presented via user-interface controls referred to herein as “prompt assistors.” In one example, a prompt assistor can present a plurality (e.g., a grouping, a collection, a hierarchy, etc.) of related user-selectable options (also referred to herein as “prompt options”), such as an organized collection of words, graphical representations of words (e.g., images, symbols, etc.), etc. that a user can select from to indicate their preference regarding the prompt used for dynamic content generation. The processor uses the user selections to generate a prompt (e.g., to generate a prompt text string comprising text prompts, image prompts, prompt parameters, etc.). For example, in some embodiments, the processor presents, as a prompt assistor, a group (e.g., a window, screen, wall, etc.) of words or pictures that indicate selectable options to construct the prompt. For example, constructing a music audio prompt screen could contain all the musical instruments and types of music genres (e.g., Pop, Rock etc.,), year, artist style, etc., from which a player can choose one or more combinations of words, pictures, etc. In one embodiment, the processor uses pre-generated prompts to pick from and provides selection options to change specific words from the prompt/script. For example, the user can specify a preference for a “dog dancing on an elephant” by first touching a word “dog.” In response to detecting the selection of the word “dog” the processor shows, via the prompt assistor, possible other words as related additions, alternatives, extensions, modifiers (e.g., nouns, adjectives, etc.), sub-categories, etc. to pair with the selected word “dog” (e.g., the prompt assistor suggests the words “cat,” “monkey,” “elephant,” etc.). In another example, in response to a user input that selects the words “dog,” the processor may present, via the prompt assistor, prompt options of words like “brown dog” or “Bull Dog.” In another example, touching on the word ‘dancing’ may present prompt options such as “dancing happily”, ‘walking’, or ‘sitting.’ The words on the prompt may have superimposed operator symbols, such as the ‘+’ sign or “<>” on either side of the word to extend the word. Furthermore, the prompt assistor can provide instant feedback. For example, touching a word “guitar” may play a sample of guitar music. In some embodiments, the prompt assistor can be provided based on a subscription model or preferred player model, such as where specific levels of prompt construction (e.g., access to specific words, levels of words, categories, subcategories, etc.) are available based on the level of the subscription. In some embodiments, the processor can permit the construction and/or use of prompts, dynamic generation of gaming content, etc. based on a reward or privilege awarded to a player. For example, the processor can provide (e.g., based on base-game events, based on bonus-game events, based on player activities, based on tournament results, based on loyalty-account levels, etc.) a reward (e.g., a loyalty-account coin, a badge, etc.) that enables the access to, and/or use of, the artificial intelligence model (e.g., the machine learning model). In some embodiments, the processor can provide differing levels of access to, or use of, a machine learning model, such as by awarding a player a priority access to a queue for use of the machine learning model, awarding a faster output time of the machine learning model or higher- quality output of the machine learning model (e.g., the processor provides a quicker output of the machine learning model for a higher-priority access, such as an output that completes in 5 second, whereas the processor provides a slower output of the machine learning model for a lower-priority access, such as an output that completes in 15 seconds); etc.

In one embodiment, the processor presents a plurality of different user-interface, input controls, where each input control has a grouping of sub-options. The input controls can be organized or physically positioned in a layout, an order, etc. that the processor can use (at processing block 408) to construct a composition of prompt tokens (e.g., a syntactical composition, a standard word order, a sentence structure, grammar, etc. of the prompt tokens). Another example of a prompt assistor includes reels of user-selectable prompt options (e.g., words, pictures, etc.). For example, the processor presents a number of reels, where each reel shows a specific option item, category, etc. from which the player can choose one or more combinations. For example, the prompt assistor can comprise multiple reels, each associated with a different category or subcategory for selection (via user input of the reels). For instance, the processor can, in response to selection of a given category (e.g., a “music” category), present reels to specify the sub-categories for selection (e.g., subcategories of the “music” category). For instance, a first reel may be associated with a specific musical instrument style, a second reel specifies a music genre, a third reel specifies a singing style, a fourth reel specifies a musician style, etc. In another example, the prompt constructor can provide an option to generate an avatar, hence the processor can animate, as the avatar prompt assistor, reels with each reel representing a different aspect of the avatar (e.g., faces, skin tones, eyes, noses, hair styles, body types, outfits, armor, etc.,) from which a realistic or cartoon avatar can be created. As the user selects the different prompt options, the processor depicts the prompt sentence as it is being constructed (e.g., as the user selects the prompt options for “dog,” “flying,” and “clouds,” a preview of the prompt sentence is depicted as “dog flying through clouds.”). In some embodiments, the processor presents, via the reels, conjunctions like ‘and’, ‘or’ and ‘not’ to assist in prompt constructions. For example, the word reels may contain a conjunction reel in between the different word options. For example, a first reel may provide the prompt options to select the word/image for “dog” and a second reel may provide the option to select “cat.” A third reel (e.g., presented between the first reel and the second reel) can include the prompt options to select either “and,” “or” or “not.” The user can manually spin the third reel to select the “and,” “or,” or “not.” Depending on what is chosen in the third reel will determine the conjunction used in the constructed prompt text string (e.g., if “and” is selected, then the prompt text string would read “dog and cat;” if “or” is selected, then the prompt text string would read “dog or cat;” if “not” is selected, then the prompt text string would read “dog (not cat).”) In another example, as shown in FIG. 5A, a first prompt-option reel (i.e., reel 501) presents images of prompt options to select a royal-card rank. A second prompt-option reel (i.e., reel 502) presents images of prompt options to select a royal-card suit. A third reel (i.e., reel 503) presents options for relating the selectable options from the reel 501 and reel 502. For instance, the processor detects selection of option 511 (e.g., indicating that a player prefers the “Q” or “Queen” rank symbol). Furthermore, the processor detects selection of option 512 (e.g., indicating that a player prefers the “Heart” suit symbol). Furthermore, the processor detects selection of option 513, which specifies the conjunction “and” signifying a preference for dynamically generated gaming content to include both the “Q” rank and the “Heart” suit.

In one example, a processor can detect prompt-related data via a ticker. For instance, a ticker (e.g., similar to a breaking-news ticker) can crawl across the bottom of a screen. The ticker includes selectable prompts or prompt assistance suggestions. In some embodiments, the ticker presents suggestions based on the situation (e.g., based on detected events or activities).

In another examples, a prompt assistor includes a voice detector that detects when a user hums, whistles, or sings a tune, then converts the tune into music, searches the tune from a library of existing tunes, etc. The prompt assistor can further convert a human-made sound into a real sound, such as by converting a human growl sound into a lion growl sound, converting a human siren animal sound into a real siren sound, etc.

In another example, the processor presents a limited number of selectable or usable prompt options for generating prompts and/or dynamically generating gaming content. For instance, the processor can provide initial options, such as initial prompt options and/or authorized initial content to choose from (e.g., initial or “starting point” examples of authorized text, images, sounds, etc.), which initial options are allowed for use in generating prompts and/or dynamically generating the game asset. In some embodiments, the processor detects user input that chooses from the selection of initial prompt options. In some embodiments, the processor dynamically generates original gaming content (e.g., at processing block 410) by combination, revision, refinement, fine-tuning, modification, etc. of the selected ones of the initial prompt options, such as by modifying initially selected options or content (e.g., modifying initial basic prompts and/or initially selected images). For example, the processor detects a game theme (e.g., a dragon theme), then provides prompt options to select from various colors and/or various shapes that match the game theme (e.g., to dynamically generate an animated game-play sequence that involves a dragon). The initial prompt options provided by the processor are restricted to the dragon theme. For example, the processor presents a few prompt options, such as only a few colors (e.g., yellow, red and black) and only a few pre-generated images of the particular type of animal that matches the theme (e.g., only three example images of dragons are provided: a large winged dragon, a smaller serpentine dragon, and an aquatic dragon). The player can select from the limited prompt options and the processor dynamically generates the animated game sequence using the selected prompt options.

In some embodiments, the processor can filter out user input that is not consistent with a specific constraint or requirement. For instance, a user may indicate (e.g., by entering/speaking words into a prompt interface), a preference to generate gaming content that features a “green dragon.” However, the processor detects that the game has a filter that will only permit “yellow,” “red,” and “black” colored dragons. Thus, the processor can filter out the word “green” and may replace it with a different color (e.g., “red”). In some embodiments, the processor may utilize the unauthorized suggestion as fine-tuning or refinement. For example, the processor may enter into the prompt an indication of “green highlights” to the dragon, so as to have some level of customization regarding the preference for the color “green” indicated by the player.

In some embodiments, the processor can present prompt options for selection using various types of visualization techniques (e.g., diagrams, graphs, charts, maps, etc.), including depicting hierarchical or related information in visually associated ways (e.g., in a hierarchical tree structure, as a spider diagram, as a concept map, etc.). For example, the processor may present prompt options using a mind map or concept map that maps related words or concepts to a central word or concept. For instance, the processor may present the word or thumbnail image of “dragon” as a central object of a concept map, with various prompt options for fine-tuning of “dragon” presented as visual appendages or connections to the word “dragon.” For example, the processor presents, via the map, the words “red,” “yellow,” and “black” indicating the prompt options that are selectable as the color for the dragon. The words “red,” “yellow,” and “black” are visually associated with the word “dragon” such as by a connecting image or effect (e.g., a connecting line, a common background, a common visual effect, a shared border, etc.). In another example, the processor presents, via the map, sub-options related to the central object/concept. For example, connected to the word “dragon” may include objects that indicate the words “color” and “body type,” thus indicating a subtype or subcategory of the central object/concept, such as an attribute for the “dragon.” When a user selects the word “color,” for example, then the processor presents the prompt options for color (e.g., the words “red,” “yellow,” and “black” pop up as objects that are visually connected either to the sub-concept object of “color” or to the central-concept object of “dragon”). FIG. 5B illustrates one example of a list 520 of prompt options 521, 522, 523, and 524 related to a scene setting for a specific kind of background or highlight artwork. For example, a user selects option 521. After selecting option 521, sub-options 531, 532, 533, and 534 appear (e.g., pop up) in connection with the selected option 521. The user further selects one or more of the sub-options, such as sub-option 531 and sub-option 534.

The processor may present prompt options for selection in various contexts, such as for game-play assets, game-help assets, game-configuration assets, etc. For example, the processor may present a chatbot prompt screen that a user (e.g., a technician) can utilize to view prompt options and/or sub-options related to game setup, game attendance/administration, machine configuration, error/fault correction, etc. In the prompt screen, the processor may present an option to select “firmware.” The processor can present sub-options related to the firmware or firmware related to specific hardware items, such as a “bill validator” sub-option, a “printer” sub-option, a “central processing unit/CPU” sub-option, etc.

Other examples of detecting user-related data may include detecting data via use of help prompt options. For example, a player may ask for specific help by pushing a help button an indicating a request or suggestions, such as “My bill/ticket is not getting accepted” or “Suggest me a game to play for an hour before my flight,” from which the processor can dynamically generate a gaming element or asset that provides the requested help or suggestion.

In some embodiments, the processor can gather prompt-related data that is collaborative amongst multiple users. For example, players can collectively create a prompt prose by each one contributing parts of it. For example, in a community gaming environment, each player can choose a selectable game object (e.g., a weapon/shield) which would be collectively used to generate a final character representing the community bonus game. In another example, each player may be assigned a category from which they choose the prompts. For example, in creating a dragon for a community bonus game, one player chooses one attribute for the dragon (e.g., the color) while one or more other players chooses a different attribute for the dragon (e.g., a roar sound, a type or pattern of movement, a power level, etc.). In another example, each player creates a character and submits it (e.g., via a bonus game field, via a prompt assistor, etc.). Furthermore, in a community game environment, players can be awarded for matching the expected content from their chosen prompts (e.g., a specific player is awarded if they provide prompts, or prompt-related data, that dynamically generates a dragon that most closely match's the community bonus game's dragon).

In some embodiments, the processor can gather prompt-related data (e.g., user-related data) by obtaining information from a mobile device (e.g., a smartphone, a tablet, a personal mobile device, etc.) communicatively coupled to the gaming machine (e.g., wirelessly coupled to communication device (e.g., a personal area network (WPAN) device, a Bluetooth Low Energy (BLE) device, etc.) configured to communicate via a short-range, wireless protocol (e.g., via Bluetooth® technology). The mobile device may be configured to present a mobile application from which a registered patron can provide user input. In some embodiments, the mobile application can communicate with the cloud-computing platform 142 and/or the player interface device 111 via an application programming interface (API) developed using a software development kit (SDK). In some embodiments, the communication device communicates with the mobile device, the player interface device 111, etc. via an encrypted communication channel.

In other examples, the processor can detect prompt-related data in other ways. For example, prompt assistors can suggest well-known game designs or designer styles to select from, famous music or musician names/styles, examples of famous artwork or artist name/styles, etc. In addition, the processor can allow for specific modifiers to be used, created, customized, etc., such as certain types of photography filters, lighting settings, cinematic angles, close-ups, lengths or durations, camera movements, art type (e.g., realistic, cartoon, etc.), negative prompts (e.g., “not,” “no redundancy,” “no common answers,” “no text in images,” etc.), and so forth. The processor can also present a search feature, such as a search box that can suggest and/or auto-fill with possible matching prompts.

In yet another example, the processor can detect, as the prompt-related data, casino-related data (e.g., stored in database 126), such as casino event data, security data, tournament data, hospitality data, loyalty program data, accounting data (e.g., data from a Slot Accounting System (SAS) protocol), patron traffic data, offers, advertising, etc.), gaming machine data, configuration data, game administration data, fault/error correction data, log data, event-history data, etc. The processor can generate (e.g., at processing block 408) a prompt that includes the casino-related data (e.g., to present an offer, to indicate a start of a tournament, etc.).

Other examples of gathering prompt-related data may include detecting environmental data, such as data collected about a gaming environment (e.g., around a gaming machine, within a section of a casino, at a specific geographic location, etc.). Environmental data can be obtained via environmental sensors, via security sensors, via patron tracking location/motion detection devices, etc.

Yet other examples of gathering prompt-related data includes detecting calendar or time related events, such as seasonal events, holidays, special casino events, tournament start/end events, travel schedule, etc.

Referring again to FIG. 4, the flow 400 continues at processing block 408 where the processor generates, via the artificial intelligence model (e.g., the machine learning model) using the prompt-related data, a prompt. For example, the processor uses the prompt-related data to generate a prompt (e.g., to generate a prompt text string comprising prompt text, image prompts, prompt parameters, etc.). Prompt text includes a text description of what original content (e.g., imagery) the machine learning model will dynamically generate. Image prompts include network addresses or online locators (e.g., Uniform Resource Locator (URLs) to one or more electronic/digital files (e.g., image files, sound files, etc.) that include reference content that the processor uses to influence a composition, style, color, and/or other content characteristic of the dynamically generated gaming content. Prompt parameters include instructions and/or values that change how the original content (e.g., an original image) is generated, such as an aspect ratio parameter, a variation/chaos parameter, a negative prompting parameter, a seed number parameter, a timing parameter, a version parameter, a stylizer parameter, a lighting parameter, an upscaler parameter, a prompt weight parameter, etc. In some embodiments, the processor (e.g., via the prompt generator 118) organizes the prompt tokens such that a first portion of the prompt includes image-prompt tokens, a second portion of the prompt includes prompt text tokens, and a third part of the prompt includes prompt parameters.

In one embodiment, the processor generates the prompt based on analysis of the prompt-related data. In some embodiments, the processor can perform varying levels or types of analysis. For instance, in the case of a prompt assistor, the processor can analyze a structure (e.g., a word order, a layout, etc.) of selected prompt options (e.g., a sequence or order of the relative physical positions of prompt reels or other input controls) and generate an equivalent or corresponding composition structure (e.g., a syntax, a standard word order, a grammatical structure, etc.) for the tokens of the prompt. For example, if a user selects “dog” from first prompt options (e.g., from a first prompt-option reel), then “cloud” from second prompt options (e.g., from a second prompt-option reel), the processor (e.g., via use of the prompt generator 118) detects the two words (and in some examples analyzes their relative physical positions, layout order, etc.) and determines that the word “dog” and “cloud” should both be included in the prompt as textual descriptions of original content of the dynamically-generated gaming content (e.g., at processing block 410), where “dog” is the first or primary subject of the prompt (e.g., because it was selected via the first prompt-option reel) and “cloud” is a second or secondary subject of the prompt (e.g., because it was selected via the second prompt-option reel). In one embodiment, a third (or interposed) reel can be positioned between the first prompt-option reel and second prompt-option reel, which third reel specifies options for a conjunctive or operator (e.g., an “and,” “or,” and “not;” a “+” symbol; etc.). The processor analyzes the specified conjunctive or operator in context of the other selected words (e.g., if the conjunctive is selected as “or” then the processor analyzes the “or” in context of “dog” and “cloud”) and generates one or more example prompts that specify either a “dog” or a “cloud” or some combination thereof. The user can select from one of the generated prompts, and/or the processor can provide a preview of the generated asset based on the example prompts.

In other examples, the processor analyzes the gathered prompt-related data to recognize an emotion (e.g., to determine a probable emotional state) of a player and then constructs a prompt based on the recognized emotion. For example, the processor uses camera(s) and/or microphone(s) to capture images and/or sound data of a player (e.g., as mentioned for processing block 406) and stores the captured data in digital files. The processor detects, via analysis of the digital files by the machine learning model, characteristics of the player (e.g., facial expressions, non-verbal cues, words, sounds, taps, grunts, etc.). In one example, the characteristics of the player are recorded in a motion history of the player (e.g., a history of detected spatial locations of the player, a history of detected locations of an associated player device, a history of GPS locations of a player smartphone, etc.). In another example, the characteristics of the player are tracked orientations of a player-related device (e.g., a player wearable, player augmented-reality glasses, a game prop, a game controller or joystick, etc.). In another example, the characteristics of the player are stored as eye-motions indicative of a player gaze or viewing angle/vector relative to a display device.

In one embodiment, the processor predicts, via the machine learning model based on detected player characteristics, an emotion (e.g., a probable emotional state) of a player (e.g., how the player is feeling, whether sad, happy, excited, bored, etc.). The processor can then use the predicted emotion to generate or select a prompt token that relates to, or is based on, the emotion. For instance, if the processor detects that a player is feeling a negative mood (e.g., sad, boredom, etc.) the processor may construct a prompt token that describes a word or phrase that will dynamically generate gaming content intended to induce a positive mood. For example, the processor may detect a negative mood of a player and may further, based on analysis of a playing history of the player, determine that the player has had a long streak of not winning a bet. In response, the processor can generate a prompt token that will generate an interesting game asset or event (e.g., a prompt token that results in interesting or exciting artwork, a prompt token that induces a particular game outcome or event (e.g., a near-miss event, a bonus feature event, a loyalty-account funded event, etc.), a prompt token that changes a setting, a prompt token that changes a math model, etc.). In some embodiments, the processor can determine, via gathering and/or analysis of user-related data, that a player prefers a certain level of game volatility; in response the processor can, while dynamically generating gaming content, automatically update a math model (associated with the gaming content) to be more or less volatile based on the detected player preference. In some embodiments, the processor can train the machine learning model to detect a player preference (e.g., for a preferred volatility) of actual players (e.g., based on actual play data) or to detect a player preference of synthetic players (e.g., based on synthetic play data). In some embodiments, the processor can feed images and/or audio to a screen to either directly or indirectly detect a player emotional state (e.g., the processor can present words or images which the player can select to indicate a current emotional state, the processor can present words or images intended to evoke a certain emotional state so that the processor can analyze how a particular player looks or sounds in that emotional state, etc.).

In some embodiments, the processor analyzes game-outcome data and jurisdictional game type to generate a specific prompt. For instance, the processor can detect that a win outcome occurs for a first type of wagering game (e.g., a 10-credit win for a Bingo game). The processor determines that the game type is of a certain jurisdictional classification that allows the win outcome to be presented as a second type of game, such as a slot-type game. For example, casinos within certain given jurisdictions are required to provide wagering game of a certain type or classification, including a non-centrally determined game, such as a slot-style and/or video poker type games that utilizes a random number generator (e.g., locally situated at a gaming machine) for each reel-stop combination according to the slot-style and/or video poker rules, pay table, odds, etc. Other jurisdictions, however, utilize a different type or classification of wagering game, such as a centrally determined game. Non-centrally determined games include a jurisdictional classification called “Class 3” games. Centrally determined games include a jurisdictional classification called “Class 2” games. Class 2 games are described in more detail in the Indian Gaming Regulatory Act of 1988, which defines “Class 2” (also referred to as “Class II”) games, as bingo other games similar to bingo (e.g., pull tabs, lotto, punch boards, tip jars, instant bingo, etc.). For instance, for some centrally determined games, the results of each depicted spin outcome on a gaming machine are based on game data (i.e., centrally determined outcome data) for an electronic bingo game that involves a plurality of gaming machines located at the operator site. Without dynamic generation of gaming content, a gaming machine would have to store a large number of pre-generated game outcomes to select from to present as a game outcome for the second type of game. However, in response to use of one or more embodiments described herein, the gaming machine does not need to store a large number of pre-generated outcomes, artwork or other multi-media files. Rather the gaming machine detects prompt-related data (e.g., the centrally determined game outcome data and/or game type/class), generates one or more prompt tokens that specify the prompt-related data (e.g., prompt text or phrase that specifies a “10-credit win” outcome as it would appear for a non-centrally determined game (e.g., a “class 3” or “slot reel” type of game). The gaming machine further dynamically generates, via the machine learning model, the original gaming content based on the prompt token(s).

In some embodiments, the processor can generate only unique prompts to avoid duplicates. For example, the processor can analyze user-related data and generate a unique prompt that would generate a unique image that cannot be used again. For example, the processor may generate a prompt to create an avatar that represents a specific individual (e.g., an avatar that resembles or depicts identifying attributes of the player, an avatar that mimics detected player motions or other actions, an avatar with a voice that mimics that of the player, etc.). Hence, the processor can store a generated unique prompt (associated with the unique avatar). The processor can further prevent that unique prompt from being used to generate a game character or to create another avatar that looks the same or similar.

In some embodiments, the processor can set a limit to a size of the prompt, such as by limiting a number of tokens, words, questions, etc. that can be included in the prompt. In some embodiments, the processor can further store generated prompts for use to retrain additional versions of the machine learning model.

FIG. 6 illustrates one example of constructing a prompt based on prompt-related data. For example, the processor constructs a prompt 600 via a command line entry at a command screen. In some embodiments, the prompt screen is presented to the user during construction of the prompt. In other embodiments, the processor hides the prompt from view. Furthermore, in some embodiments, the processor constructs multiple prompts and runs then in a batch simultaneously. For example, the processor may construct and run various prompts for various game assets presented in a game. The prompt 600 includes a command 610. The command 610 may be an instruction that is passed to the machine learning model (e.g., via an Application Programming Interface (API)) to dynamically generate the gaming content based on prompt data (e.g., based on the tokens included in the components of the prompt 600, including, but not limited to, image prompt(s) 611, text prompt 612, and prompt parameters 613). In one example, the tokens of the prompt 600 are based, at least in part, on options selected in FIG. 5A and FIG. 5B. For example, the processor detects the prompt options selected via the reels 501, 502, and 503. For instance, the processor determines, based on selection of option 511, that a player prefers the “Q” or “Queen” rank symbol. Furthermore, based on the selection of the options 512 and 513, the processor determines that the player prefers the “Heart” suit symbol. In response, the processor includes, as image prompt(s) 611, references to image files used to influence the machine learning model to dynamically generate gaming content, such as a reference to an image file 623, which includes font and/or texture details associated with the “Q” rank symbol, or image file 622 which includes details for a particular shaped heart symbol. The processor may also reference an additional image file 621, which includes a likeness of the player. In some embodiments, the processor accesses the image file 621 via authorization (e.g., via player permission or authentication) to a profile or account, such as via login to a casino loyalty account, a social media account, etc. In some embodiments, the processor selects the image via communication with a mobile device associated with the player (e.g., from the photo application of the player's smartphone). In some embodiments, the processor can select an image specified via user input. In some embodiments the processor searches through a collection of recent photos or an album of photos. The processor further determines, based on the selections of from FIG. 5B, that the player prefers an “Arctic” scene (i.e., selected option 521) with “Blue” elements (i.e., selected option 531), such as “Icicles” (i.e., selected option 534). The processor selects from words 630 (related to the selected options from FIG. 5B) and writes the selected words into the text prompt 612. In some embodiments, the processor writes or suggests replacement or additional text prompt, such as synonyms of the selected words. The processor can further write specific types of parameters 613, such as a specific aspect ratio, or a negative parameter.

Referring again to FIG. 4, the flow 400 continues at processing block 410 where the processor dynamically generates, via the artificial intelligence model (e.g., via the machine learning model) using the prompt, gaming content. In one embodiment, the gaming content is original gaming content representative of the prompt. Original gaming content may include, but not be limited to, original imagery, original sounds, original music, original screens, original user- interface objects, original chatbot sessions, original help content, original player-customized content, original text, original two-dimensional and/or three-dimensional images, original animations, original layouts, original system-based content, original game play content, original math content, original bonus content, original background content, original cabinet light shows, original bank-wide light shows, original reel/wheel profiles (e.g., fast/slow spin, nudge, etc.), an original virtual dealer (e.g., an original, dynamically generated dealer character), etc. In one embodiment, the gaming content can present (e.g., animate) at least a portion of a random outcome of play of the wagering game. In some embodiments, the processor can dynamically generate a first level of gaming content (e.g., a low resolution version of content, a basic geometric shape, an initial authorized or licensed image pattern, a specific seed parameter, etc.), and, based on prompt-related data gathered (e.g., at processing block 406) fine tune or modify the first level of dynamically-generated gaming content, producing a second level of dynamically-generated gaming content (e.g., a higher-resolution version, a fine-tuned version, a customized version, etc.). In some embodiments, the fine-tuning can shape the first level of gaming content, such as by adding textures, colors, additional shapes, character details, background refinement, layout adjustments, game-outcome information, response or interaction to player activity or emotional state, adjustment to image format, filter, setting, brightness, contrast, etc., adjustment to music beat, adjustment to camera settings (e.g., content camera angles, zoom levels, depth of field settings, lighting settings, aperture settings, etc.), and so forth. In some embodiments, the processor utilizes inpainting (e.g., the processor reuses a dynamically generated image as an input image to fill in missing areas of an image) or out-painting (e.g., the processor reuses a dynamically generated image to fill out or extend an area around an image) to fine tune the dynamically generated gaming content.

In some embodiments, the processor can, via the machine learning model, dynamically generate video content of characters, script text, music, etc. for an animated game sequence, then the processor can, via the machine learning model, manage aspects of content coordination or synchronization, such as by synchronizing generated character audio of the script text to lip movements of characters, synchronizing or coordinating movement or actions of characters based on a dynamically generated story outline, synchronizing scene-action timing to dynamically- generated music, etc. In some embodiments, the processor can generate audio with a voice-mimic feature in different languages, accents, voice styles, uniquely identifiable voice patterns, etc. In some embodiments, the processor dynamically generates voice content according to user preference (e.g., of language, dialect, regional accent, voice style, slang, etc.). For example, the processor can detect a user preference for a voice or language setting (e.g., when a player logs in to a player account using the player interface device 111, when the player accesses a settings panel of the gaming machine 110 to manually indicate preferences, via language-detection by the machine learning model of a player voice, etc.). The processor can then use the detected user preference to dynamically generate and/or fine-tune a character (e.g., the processor detects a preferred language of Spanish and a preferred and/or authorized voice pattern (e.g., the player's voice pattern, a celebrity voice pattern, etc.) then the processor dynamically generates a character that speaks Spanish in the style of the preferred and/or authorized voice pattern).

In some embodiments, the processor dynamically generates a profile or a player avatar from prompt data that uses a picture of a player face (captured from a camera, light sensor, etc.) The processor can further capture and incorporate user motion into the generated video or image of an avatar, of game play moves, etc.

In some embodiments, the processor generates three-dimensional (3D) content from two-dimensional (2D) content. For example, the machine learning model can analyze a few images of the 2D content (e.g., two-dimensional pictures) of the same scene, object, etc. taken from different camera angles. The machine learning model can predict an equivalent 3D scene, object, etc. based on the analysis of the 2D content.

In some embodiments, the player interface device 111 can intercept an image feed of gaming content from the game controller 112 and rescale the gaming content to fit as a picture-in-picture within a player user interface that presents system-based content. Thus, the processor can rescale the gaming content, via the machine learning model, while dynamically generating the system-based content.

In one embodiment, the processor can, via the machine learning model, dynamically generate a single reel symbol and then transfer the generated style to other reel symbols. For example, the processor can generate a base or default symbol appearance (e.g., a King or “K” symbol having a specific font style, texture, shape, color, etc.), which the processor uses for all other similar types of symbols (e.g., the processor generates the appearance of all other royal symbols (e.g., the Ace or “A,” the Queen or “Q,” and the Jack or “J”) based on the appearance of the dynamically generated base or default symbol.

In some embodiments, the processor dynamically generates gaming content based on a condition or situation that is detected or intended to be used for a specific purpose or aesthetic, such as for expressing a specific theme, for performing a celebration, for indicating a game event, etc. For example, the processor can dynamically generate, via the machine learning model, the game content, such as the game symbol (e.g., the “K” symbol mentioned previously). Further, the processor detects a specific time/calendar related theme (e.g., based on a season, time of day, holiday, weather condition, etc.), such as a “snowstorm” theme (e.g., to reflect current snowy weather, to celebrate a Winter holiday, etc.). The processor, thus, engineers a prompt (e.g., via processing block 406 and processing block 408) that specifies relevant words or phrases (e.g., “snowstorm,” “snow,” “in a snowstorm,” etc.), and dynamically generates gaming content that appears to be covered in snow. The processor does so without requiring the storage of variations of graphics for all possible variations or conditions that could be depicted, which would amount to an inordinate or impractically large amount available graphics. Rather, the processor uses the trained machine learning model to generate, store, access, etc. efficient prompts (textual prompts) that are used to dynamically generate the graphics at game runtime. For example, in FIG. 7, the processor utilizes prompt 600 (shown in FIG. 6) to dynamically generate original gaming content. For example, the processor dynamically generates, via the machine learning model, original artwork 751 that combines at least portions of the images presented in the image files 621, 622, and 623. The processor presents the original artwork 751 via display device(s) 760, such as within a secondary presentation device 761. The processor further dynamically generates the appearance of blue icicles on the various game assets of the wagering game presented via the secondary presentation device 761 and also via a primary presentation device 762. For instance, the processor dynamically generates game assets for presentation in the game array 730. The game array 730 includes slot reels 710, 712, 714, 716, and 718. In one embodiment, the processor dynamically generates reel symbols 755, which are used to indicate an outcome of the game as specified in a dynamically generated pay table 752. In one embodiment, the processor dynamically generates, based on player preferences, a pay table that gives better odds to the game symbol(s) that were selected as preferences by the player. For example, because the player selected the “Q” symbol from prompt reel 501 (e.g., see FIG. 5A), then the processor modifies the pay table 752 to have a payout of “50X” a bet for the appearance of four “Q” symbols in a winning line on the game array 730, whereas an appearance of four other (non-selected) royal rank symbols (i.e., “A,” “K,” “J”) would only have a payout of “40X” the bet. Likewise, the processor modifies the pay table 752 to have a payout of “15X” a bet for the appearance of three “Q” symbols in a winning line on the game array 730, whereas an appearance of three other (non-selected) royal rank symbols (i.e., “A,” “K,” “J”) would only have a payout of “10X” the bet. As shown in FIG. 7, a random game outcome results in a reel-stop configuration in the game array 730. The processor presents the reel symbols 755 on pay line 722. The processor further detects that the occurrence of the reel symbols 755 on the pay line 722 results in a “15X” bet reward. Thus, the processor detects an amount of the bet (e.g., as shown in bet meter 702), and multiplies it by “15” (based on pay table entry 753). The winning amount is indicated in win meter 704 and is added to a credit balance shown in credit meter 700. Furthermore, a game highlight 770 indicates (e.g., via dynamically generated gaming content) a presentation of the winning amount.

In some embodiments, the processor provides a user interface by which a casino operator can preview (e.g., play with) prompts and/or dynamically generate gaming content prior to game runtime. The casino operator can then lock in use of only certain ones of the prompts and/or dynamically generated gaming content before game deploy or use.

In some embodiments, the processor provides a generative artificial intelligence (AI) chatbot, similar in style to the ChatGPT chatbot manufactured by OpenAI, L.L.C. The processor can present the chatbot on a display of a gaming machine (e.g., via presentation device(s) 114) such as during setup of the game, for help assistance through any game-related events or errors, to generate and/or preview prompts, during game play, after game play, etc. In some embodiments, the chatbot can be trained from gaming machine data, like help screen information, so it can answer verbally and/or show appropriate help screen(s) for questions about how to play. Furthermore, the chatbot can also be trained on all the setup/diagnostics information from the gaming machine which an operator (e.g., casino technician) can use to get diagnostics information, such as a firmware version of a bill validator device used at the gaming machine. Generated data from game play and log files can also be used to train and answer real time data like how many games were played at the gamine machine during a certain period (e.g., today, last week, etc.). The chatbot can further provide an interface for use by the player, such as to provide prompt suggestions, preview dynamically generated gaming content, etc. The chatbot can further save a chat history for the user (e.g., for the operator, technician, pit boss, dealer, player, etc.). In some embodiments, the chatbot can provide gambling help or assistance (based on training from an authorized source, such as the game developer system 150), such as a chatbot that can show or suggest optimal- strategy play tactics, aggressive-strategy play tactics, long-term/endurance play tactics, responsible gaming tips, etc. In some embodiments, the chatbot can be provided as a help-tool companion or “personal assistant” to provide context-based help. Furthermore, in some embodiments, the processor integrates with machine learning models and applications provided by a native operating system (OS) (e.g., integrates with machine learning models incorporated into the Windows® Operating System software, available from Microsoft Corporation).

In some embodiments, the processor saves the dynamically generated gaming content, along with other related user and/or use information (e.g., game-play data, prompt-related data, generated prompts, player-ratings of content, etc.) and can provide the saved gaming content and/or other information to the game developer system 150 (and/or the cloud computing platform 142) for analysis, re-training, etc. For instance, the game provider system 150 can analyze various dynamically generated bonus games to determine which dynamically generated bonus game met or exceeded a metric threshold (e.g., a metric that indicates the most elicited player reactions, produced the most positive emotional player responses, received the greatest post-presentation betting increases, produced an increased player retention or engagement, etc.). The best performing dynamically generated gaming content can then be used to train, retrain, or otherwise update the machine learning model to engineer improved prompts, to dynamically generate improved gaming content, to provide improved customizations, etc. The game provider system 150 can utilize various training algorithms and/or techniques including using zero, one or few shot learning to dynamically generate and/or fine tune gaming content. Furthermore, in some embodiments, the game provider system can implement a subscription model in which new games can be generated according to a specific interval or schedule.

As mentioned, the machine learning model can be trained via the game developer system 150 and/or cloud computing platform 142 prior to the machine learning model being made accessible for runtime use. The training can involve a number of parameters and/or hyperparameters related to specific constraints (i.e., constraint data) or development data, such as game development constraints (e.g., design requirements, jurisdictional constraints, game constraints, etc.) that are stored in database 152 or accessible from jurisdictional settings or servers associated with a casino location, licensing content and/or licensing constraints (e.g., authorized and/or licensed content data) stored in database 153, or other data (e.g., user/user data, casino-related data, actual player feedback, ratings, player reactions to previously generated gaming content, synthetic-player testing, etc.) stored in database 154. In some embodiments, the game developer system 150 and/or cloud computing platform 142 can select constraint data based on user input during development of a wagering game and/or based on automatic selection or analysis of constraint data stored by, or accessible to, the game developer system 150 and/or cloud computing platform 142. In some embodiments, a machine learning model can be trained, based on electronic analysis of constraint data, to dynamically generate original gaming content compliant with the constraint data. In one example, a design constraint may be associated with a required use of one or more game assets of a wagering game designed for use by a gaming machine. The machine learning model can be trained to, based on the design constraint, dynamically generate original gaming content based on the required use of the one or more game assets. In another example, constraint data specifies requirements for presentation of gaming content according to a game theme. The machine learning model can be trained to dynamically generate a version of gaming content that has artwork consistent with the game theme. For example, the game developer system 150 can train a machine learning model on a set of artwork files previously generated for, and/or used with, a particularly themed game, so that the dynamically generated output can be specific to (e.g., consistent with) the set of artwork. For instance, the game developer system 150 can train the machine learning model on all existing and/or authorized artwork (e.g., licensed content data, original artwork, etc.) for a given theme, game title, etc. In one example, the machine learning model can be trained to analyze licensed content and automatically determine one or more characteristics (e.g., unique characteristics) that identify or describe the licensed content. The machine learning model can dynamically generate original gaming content that is based on (e.g., that resembles, that includes at least one of, etc.) the one or more characteristics. Thus, when the trained machine learning model is used at game runtime, the machine learning model dynamically generates original art images (and/or fine-tuned images) for that particular game theme, title, etc. based on the training. In some embodiments, the game developer system 150 can limit use or training context to an internal network or a specific content provider (e.g., an authorized third-party stock image database) from which the machine learning model can only pull images for that limited use or training context (e.g., the machine learning model is trained to generate a game meter, or other asset, that looks like an already authorized theme, artistic style, etc.). In one example, the license content data (e.g., stored in database 153) includes content from a stock-graphics provider (e.g., from Shutterstock Inc.). The game developer system 150 (and/or other devices, such as the gaming machine 110, the edge computing device 116, the cloud computing platform 142, etc.) can determine (e.g., during training and/or during runtime) whether a commercial database was used to train, fine-tune, or in any other way influence an appearance or outcome of a dynamically generated asset. The system or device can then generate a license fee based on the degree of influence.

The game provider system can utilize different datasets to use and/or train the models, such as to limit data access to a particular role (e.g., operator, technician, player, etc.). For instance, player datasets may include player-related data stored in database 124 and/or database 154, but may not include casino-related data (e.g., in database 126), or other data related to operator/technician options, such as how to setup a game or how to access/use game play history/diagnostics. Technician-related data stored in database 126 and/or database 154 may include selected options, generated prompts, generated assets, etc. that occur from use of the gaming machine by a technician. The processor can thus utilize and/or make accessible datasets that are unique to the user role or context in relation to the gaming machine or gaming session.

In some embodiments, the game developer system 150 (or other device) can determine ownership and/or royalty possibilities of generated assets/content and prompts based on blockchain protected records (e.g., detects ownership and/or royalty settings associated with user, transfer, etc. of a non-fungible token or NFT). In some embodiments, the game developer system 150 can train the machine learning model to keep specific graphics of a certain art theme or style on a gaming screen for a specific amount of time, or to slowly change images, so as to maintain some consistency of art theme or style (e.g., to ensure some recognizable trademark/copyrighted imagery).

In some embodiments, the game developer system 150 can set up a generative adversarial network (e.g., a GAN) as the machine learning model. In some embodiments, the game developer system 150 trains the machine learning model on player history data. In some embodiments, the player history data is obtained from actual user data (e.g., obtained from actual player use data, such as from player game history). In other embodiments, the player history data may be obtained from synthetic play. For example, the game developer system 150 can train the machine learning model as one or more synthetic players that perform actions which generate simulated player use data. The synthetic player(s) can be modeled from actual player use data. Furthermore, the game developer system 150 can fine-tune the generically trained synthetic player based on the actual player data obtained from actual play (e.g., based on player-related data obtained from database 124 gathered by the CMS 122 within the casino system 130), so as to be trained more accurately to actual player preferences. The game developer system 150 further includes the ability to control the training model locally or from a cloud (e.g., from the cloud computing platform 142) to filter or modify already existing gaming content or add to existing gaming content. In some embodiments, the game developer system 150 provides a game asset approval process to get approval of newly generated content from casino operators, manufacturers, regulators, etc.

In some embodiments, the machine learning model is trained to generate instructions or release notes, such as by feeding the machine learning model relevant images/videos. For example, image(s) or video that depicts or shows how to play a game can be provided to the machine learning model, which in turn dynamically generates playing instructions. The playing instructions can be regenerated and/or refined based on additional training of images/videos captured during actual game play (e.g., based on the user data or use data in either database 124 or 125 pertaining to captured game play and/or player response to game play). In some embodiments, the machine learning model is trained to recognize specific sounds, such as to recognize a user voice, to detect operator voice instructions, etc.

In some embodiments, the game developer system 150 trains the machine learning model to dynamically generate gaming content based on one or more (e.g., a set) of mathematical or statistical requirements/constraints. For example, the machine learning model can be trained to create reel strips (e.g., original reel-strip artwork) with a certain reel-strip distribution. For instance, the machine learning model can be provided with a set of symbols for a particular game. The machine learning model can, given the set of symbols, determine the set of all winning combinations. Based on the winning combinations, the machine learning model can produce reel strips that, based on the mathematical or statistical requirements/constraints, meet or comply with a required or desired reel-strip distribution. The machine learning model can further rely on related mathematical text, data, structures, expressions, etc. such as an expected theoretical return to player, a payout requirement from a pay table, etc.

In some embodiments, the game developer system 150 provides a jurisdictional conversion process. For example, the machine learning model can detect jurisdictional rules associated with a certain classification of game (e.g., detects existing game rules for non-centrally determined games, for centrally determined games, etc.), existing constraints (e.g., a maximum bet no more than a given amount, a maximum win is under a specific amount, etc.), and so forth. The machine learning model can then convert game mechanics, math models, symbol distribution, pay tables, etc. to generate a different class of game (e.g., dynamically generates, based on a game outcome for a centrally determined game (e.g., a class 2 game), gaming content for a non-centrally determined (e.g., a class 3) game). In some embodiments, the machine learning model can further detect a requirement or constraint for a given type of lottery game or jurisdiction to generate a symbol determination table (e.g., detects game constraints and/or jurisdictional requirements for a state lottery and dynamically generates a symbol determination pay table for an original state lottery game). In some embodiments, the machine learning model can read a spreadsheet (e.g., an Excel® software spreadsheet) that includes math computations/constraints, jurisdictional requirements, etc., and the machine learning model can determine whether a developed game meets the constraints and/or requirements, such as by flagging odds, maximum bets, etc. that do not fit the constraints/requirements. In some embodiments, an electronic processor provides (e.g., via a communications network, such as telecommunications network 140) access to a version of a trained machine learning model (e.g., stored via the cloud computing platform 142) that responds to requests made, by the gaming machine, during play of a wagering game. The electronic processor can determine, in response to electronic communication with a geographic tracking device of the gaming machine, that the gaming machine is at a geographic location within a jurisdictional region associated with the jurisdictional constraint. The electronic processor can further dynamically generate, in response to determination of the gaming machine being within the geographic location, a version of original gaming content that is compliant with a jurisdictional constraint (e.g., with a jurisdictional presentation requirement for a wagering game, a game outcome, etc.).

In some embodiments, the machine learning model is trained to convert data from a specific gaming protocol to another, such as converting data from the Slot Account System protocol (which is a low-speed serial protocol communicating through a serial port to a single host) to the Game to System (G2S) protocol (which is a high-speed network protocol supporting TCP/IP communication channels between gaming machines and multiple G2S hosts). Thus, the processor can, via use of the machine learning model, run applications on either the SAS protocol or the G2S protocol.

In some embodiments, the game developer system 150 can utilize a machine learning model (e.g., the ChatGPT tool) to generate code, code comments, interpretations of code, etc. for a particular design problem or need. For example, the machine learning model can transform coordinates from one graphical object (e.g., from one triangle) to another location in another triangle, such as code to transform barycentric coordinates. An example of transforming location/coordinate values via a gaming table system is described in U.S. Pat. No. 11,495,085 issued Nov. 8, 2022, which U.S. Pat. No. 11,495,085 is incorporated by reference herein in its entirety.

Referring again to FIG. 4, flow 400 continues at processing block 412 where the processor presents, via a presentation device of the gaming machine, the dynamically generated gaming content. For example, referring momentarily to FIG. 1 the content generator 119 provides the dynamically generated gaming content to the game controller 112, which the game controller 112 presents via the presentation device(s) 114. In one embodiment, the processor animates at least a portion of the gaming content, such as animating a presentation of game play for a wagering game, animating a presentation of a game outcome, etc. In another embodiment, the processor animates a presentation of a game feature, a game help screen, etc. For example, as shown in FIG. 7, the processor animates presentation of the dynamically generated gaming content (e.g., original artwork 751, pay table 752, reel symbols 755, game highlight 770, etc.). In yet other examples, the processor dynamically generates gaming content to add to existing gaming content and/or to remove or delete a portion of the existing gaming content using a prompt. For example, in one embodiment, the processor (at processing block 406) gathers, prompt-related data associated with a preference to delete or remove a certain type of gaming content that is presented or anticipated for presentation, such as by changing or removing a game asset (e.g., a graphical element, a sound, etc.) that would normally be presented for that game theme. For instance, a game theme may be a fantasy type theme that would normally present a “dragon” game asset. However, the processor may determine a prompt-related indicator (e.g., by the player, by a casino operator, etc.) to either remove any images of dragons and/or to replace the image of the dragon with something else (e.g., with a dinosaur instead). The processor (at processing block 408) generates a prompt that specifies a negative parameter (e.g., “no dragons”). Consequently, the processor (at processing block 410) can dynamically generate original gaming content that does not include a dragon (e.g., seamlessly removes any anticipated dragon from being in the dynamically generated scene and/or replaces a dragon-related game element with a different preferred element, such as a dynamically generated image of a dinosaur).

FIG. 4, described by way of example above, represents a data processing method (e.g., algorithm(s) that corresponds to at least some instructions stored and executed by a processor and/or logic circuitry. Other embodiments can utilize processors and/or logic circuitry of any of the devices described for FIG. 1, FIG. 2, FIG. 3, FIG. 5A, FIG. 5B, FIG. 6, or FIG. 7 to perform the above-described functions associated with the disclosed concepts. For example, in some embodiments, an edge computing device is not used, rather a gaming machine (e.g., gaming machine 110 or gaming machine 210) can incorporate the prompt-generator 118 and/or the content generator 119, hence the gaming machine 110 can communicate directly with, and/or directly use, the machine learning model and any associated elements. Furthermore, other devices may be optional or used in other configurations. For example, the player interface device 111 may be optional, hence the gaming machine 110 can be in direct communication with the casino management system (e.g., CMS 122), the gaming server 135, etc. Furthermore, in another example, the sensors 113 may be incorporated into devices other than the gaming machine 110 (e.g., may be incorporated into a gaming table, may be incorporated into a casino security system, may be incorporated into a mobile device, etc.). For example, a processor can detect user input at a gaming table (e.g., by a dealer at a dealer station, by a player at a player station, by selection of presented or projected gaming content, by computer-vision detection of user gestures at a gaming table, etc.), and can gather prompt-related data based on the detected user input. The processor can further gather prompt-related data. For example, the processor can capture an image of a player and determine, based on analysis of the image (e.g., via an artificial intelligence model), a profile or account of the user, from which user data can be obtained and used as prompt-related data. In other embodiments, the processor can present (e.g., present at a user-interface device of a player station, project onto a surface of a gaming table, etc.) prompt-gathering objects, such as prompt assistors. The processor can detect use of the prompt-gathering objects to gather the prompt-related data. The processor generates a prompt based on the gather prompt-related data and dynamically generates, using the prompt, gaming content, which can be presented at the gaming table (e.g., presented on digital signage at the gaming table, projected onto the surface of the gaming table, etc.). An example gaming system that can detect objects in a gaming environment around a gaming table and which can project content onto a surface of the gaming table is described in U.S. Pat. No. 11,495,085 issued Nov. 8, 2022, to Lyons et al., which U.S. Pat. No. 11,495,085 is hereby incorporated by reference herein in its entirety.

All patent applications, patents, and printed publications cited herein are incorporated herein by reference in the entireties, except for any definitions, subject matter disclaimers or disavowals, and except to the extent that the incorporated material is inconsistent with the express disclosure herein, in which case the language in this disclosure controls.

Any component of any embodiment described herein may include hardware, software, or any combination thereof.

Further, the operations described herein can be performed in any sensible order. Any operations not required for proper operation can be optional. Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and also with all other features in all other documents incorporated by reference, without limitation. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

What is claimed is:

1. A method comprising:
detecting, by an electronic processor associated with a gaming machine, user input that indicates use of the gaming machine;
gathering, by the electronic processor in response to detection of the user input, prompt-related data;
generating, by the electronic processor based on the prompt-related data, a prompt;
dynamically generating, by the electronic processor via a machine learning model using the prompt, original gaming content; and
presenting, by the electronic processor via a presentation device of the gaming machine, the original gaming content.

2. The method of claim 1, wherein dynamically generating the original gaming content comprises generating, by the electronic processor via the machine learning model during play of a wagering game, original imagery representative of the prompt.

3. The method of claim 2, wherein the prompt-related data comprises game-outcome data associated with one or more of a random outcome of the play of the wagering game or a prize amount associated with the play of the wagering game, and wherein the original imagery depicts at least a portion of the game-outcome data.

4. The method of claim 1, wherein the detecting the user input comprises detecting placement of a wager for a wagering game presented via the gaming machine.

5. The method of claim 1, wherein detecting the prompt-related data comprises detecting, via one or more devices communicatively coupled to the gaming machine, player-related data comprising one or more of player profile data, player loyalty account data, player preference data, player betting history data, player game selection data, player identity data, player motion data, player location data, player appearance data, or player sound data.

6. The method of claim 1, wherein generating the prompt is based on analysis, by the electronic processor via use of the machine learning model, of the prompt-related data, wherein the electronic processor uses the prompt-related data as one or more of input, parameters, or hyperparameters for the machine learning model.

7. The method of claim 1, wherein gathering the prompt-related data comprises detecting, via sensors of the gaming machine, one or more of an appearance or sound of a player at the gaming machine, and wherein generating the prompt comprises detecting, based on analysis via the machine learning model of the one or more of an appearance or sound of the player, a probable emotional state of the player, wherein the prompt includes one or more words selected based on the detected probable emotional state of the player.

8. The method of claim 1, wherein gathering the prompt-related data comprises detecting, by the electronic processor, user selections from a plurality of prompt options presented via a user interface associated with the gaming machine.

9. The method of claim 8, wherein the plurality of prompt options comprises one or more of words, graphics, or symbols presented on a plurality of input controls, wherein each input control corresponds to a respective one of a plurality of tokens of the prompt.

10. The method of claim 9, wherein the plurality of prompt options are organized according to a physical layout order, and wherein generating the prompt comprises constructing, based on the physical layout order, a syntactical composition of the plurality of tokens within the prompt.

11. The method of claim 10, wherein generating the prompt comprises constructing, based on a portion of the plurality of prompt options, conjunction tokens in the prompt.

12. The method of claim 8, wherein, in response to detecting the user selections from the plurality of prompt options, generating, based on analysis of the user selections, one or more of prompt text, image prompts, or parameters of the prompt.

13. The method of claim 1, wherein gathering the prompt-related data comprises accessing at least one digital file that specifies one or more of an identifying attribute or a detected motion of a player of the gaming machine, wherein generating the prompt comprises including in the prompt a reference to the at least one digital file, and wherein dynamically generating the original gaming content comprises incorporating, by the machine learning model, the one or more of the identifying attribute or the detected motion of the player into the original gaming content.

14. The method of claim 13, wherein incorporating the one or more of the identifying attribute or the detected motion of the player into the original gaming content comprises generating an avatar of the player using, as one or more animated attributes of the avatar, the one or more of the identifying attribute or the detected motion of the player.

15. The method of claim 1, wherein the dynamically generating the original gaming content comprises dynamically generating a level of the original gaming content based on a subscription level associated with a user account logged into the gaming machine, wherein the user account is accessible via communication, by the electronic processor, with a player interface device communicatively coupled to the gaming machine.

16. The method of claim 1, further comprising:
detecting, by the electronic processor in response to presenting the original gaming content, reaction data that indicates one or more of a preference, a rating, or a positive emotional response by a user of the gaming machine to presentation of the original gaming content; and
using the reaction data to train the machine learning model to fine tune at least a portion of the original gaming content.

17. The method of claim 1, wherein the gathering the prompt-related data comprises determining a preference associated with presentation of a game character, wherein the generating the prompt comprises generating a script for the game character based on the preference, and wherein dynamically generating the original gaming content comprises generating audio of the script and dynamically synchronizing presentation of the audio of the script to a corresponding lip movement of the game character.

18. The method of claim 1, wherein gathering the prompt-related data comprises detecting a game outcome value for a first classification of wagering game, wherein generating the prompt comprises specifying, in the prompt, a token that indicates a second classification of wagering game; and wherein dynamically generating the original gaming content comprises dynamically generating, by the electronic processor using the token, an animated indication of the game outcome value as an outcome of the second classification of wagering game.

19. A system comprising:
one or more memory devices configured to store one or more instructions; and
one or more electronic processors configured to execute the one or more instructions, which when executed cause the system to perform operations to:
detect, in response to user input, selection of constraint data associated with presentation requirements for gaming content via a gaming machine;
train, based on electronic analysis of the constraint data, a machine learning model to dynamically generate original gaming content compliant with the constraint data; and
store, for access via a communications network, a version of the trained machine learning model for use by the gaming machine.

20. The system of claim 19, wherein the constraint data specifies requirements for presentation of the gaming content according to a game theme, and wherein the operations to train the machine learning model include operations to train the machine learning model to dynamically generate a version of gaming content that generates artwork consistent with the game theme.

21. The system of claim 19, wherein the constraint data comprises a requirement for presentation of one or more characteristics of licensed content, wherein the operations to train the machine learning model include operations to train, based on the one or more characteristics of the licensed content, the machine learning model to dynamically generate a fine-tuned version of the licensed content.

22. The system of claim 19, wherein the constraint data comprises a design constraint associated with a required use of one or more game assets of a wagering game designed for use by the gaming machine, and wherein the operations to train the machine learning model include operations to train, based on the design constraint, the machine learning model to generate the original gaming content based on the required use of the one or more game assets.

23. The system of claim 19, wherein the constraint data comprises a jurisdictional constraint for a wagering game, and wherein the operations to train the machine learning model include operations to train, based on the jurisdictional constraint, the machine learning model to generate, for presentation via the gaming machine, a version of original gaming content that complies with the jurisdictional constraint.

24. The system of claim 23, wherein the one or more electronic processors are configured to execute one or more additional instructions, which when executed cause the system to perform one or more additional operations to:
provide, via the communications network, access to the version of the trained machine learning model in response to a request, by the gaming machine, made during play of the wagering game;
determine, in response to electronic communication with a geographic tracking device of the gaming machine, that the gaming machine is at a geographic location within a jurisdictional region associated with the jurisdictional constraint; and
dynamically generate, in response to determination of the gaming machine being within the geographic location, the version of the original gaming content to be compliant with the jurisdictional constraint.

25. The system of claim 19, wherein the constraint data comprises a set of game symbols and a set of statistical constraints for presentation of the set of game symbols, and wherein the operations to train the machine learning model include operations to train the machine learning model to generate original reel-strip artwork that has a distribution of the game symbols compliant with the set of statistical constraints.

26. The system of claim 19, wherein the constraint data comprises a set of math models associated with levels of volatility of game outcomes for a wagering game, and wherein the operations to train the machine learning model include operations to train the machine learning model to:
determine, based on player history data, a preferred level of volatility; and
dynamically generate the original gaming content based on the preferred level of volatility.

27. The system of claim 26, wherein the player history data is associated with one or more of actual player use data obtained from actual play of one or more players or simulated player use data derived from activity by one or more synthetic players modeled from actual player use data.
